(19) United States
(12) Patent Application Publication
(10) Pub. No.: US 2024/0328107 A1
(43) Pub. Date: Oct. 3, 2024

(54) GRAVITY BASED FOUNDATION

(71) Applicant: Mohammad Amin LAK, Schaarbeek (BE)

(72) Inventor: Mohammad Amin LAK, Schaarbeek (BE)

(21) Appl. No.: 18/293,390

(22) PCT Filed: Jul. 29, 2022
(86) PCT No.: PCT/EP2022/071375

§ 371 Date: Jan. 30, 2024

(30) Foreign Application Priority Data
Jul. 30, 2021 (EP) 21020392.3

(51) Int. Cl. E02B 17/02; E02B 17/00

(52) U.S. Cl. CPC E02B 17/02; E02B 17/0017; E02B 2017/0039; E02B 2017/0069; E02B 2017/0091

(57) ABSTRACT

A gravity base (1) for supporting a superstructure (2), comprising a base structure (100), wherein the base structure is configured to be arranged on a supporting media (3) and is configured to be connected to the superstructure (2) or to a support structure (300) which is configured to be arranged between the superstructure and the base structure, and wherein the support structure is configured to be connected to the superstructure; a ballast confiner (200), wherein the ballast confiner is configured to be filled with a ballast material (250), wherein the ballast confiner (200) is configured to confine the ballast (250) on the base structure (100), wherein the base structure and the ballast confiner are structurally independent.

The present invention relates to a gravity base and, more particularly, to a gravity base for a construction or installation and to a method for deploying the gravity base which may be used for a non-building construction such as an offshore wind turbine, an onshore wind turbine, offshore platforms for the oil and gas industry, weather stations, jackets, monopoles, light poles, masts, lattice towers for telecommunication and power transmission, stacks, chimneys, temporary structures requiring fast and easy installation and decommissioning, and so on.

The most governing loads on some tall non-building structures-such as offshore installations, offshore and onshore wind turbines, weather stations, telecommunication and power transmission monopoles and towers, light poles, masts, chimneys, temporary structures requiring fast and easy installation and decommissioning, and so on—are the horizontal loads due to environmental actions like wind, earthquake, and in case of offshore structures, also wave and current. The horizontal loads result in shear/sliding forces and overturning moments at the base of these structures. The common method to overcome the overturning moment is either to use deep foundations, such as piles, to transfer the overturning moment deep into the supporting ground, to use spread footings where the self-weight of the foundation and structure counteracts the overturning moment, or to use spatial trusses or so-called jackets together with small piles or so-called pin piles to resist the overturning moment with a couple of tension/compression reactions provided by the pin piles. In case of bottom-fixed offshore installations, in comparison with the floating installations, common types of bases are deep foundations such as piles, spread footings such as gravity-based foundations, and spatial trusses or jackets together with pin piles. A pile is a columnar element, driven or drilled deep into the ground and transfers horizontal and vertical loads and bending and torsional moments from the superstructure to the deeper layers of the site soil.

Currently most of the offshore wind turbines are based on a single large diameter pile or the so called monopile. As an example, the monopile for an 8-megawatt offshore wind turbine installed at a site with a sea depth of 35 m, may be 90 m long, with a diameter of 8 m and a wall thickness of 100 mm, which weighs about 1700 tonnes. Currently, larger offshore wind turbines of 15 megawatt, 20 megawatt, and even 27 megawatt are being studied to be installed in the offshore windfarms. For large wind turbines, the diameter, length and wall thickness of the monopiles will become very large, which make the monopiles expensive and difficult for fabrication, lifting, transportation, up-ending, and driving. For example, the monopile for a 15-megawatt offshore wind turbine installed at the North Sea with a water depth of about 40 m, may be 100 meters long with a diameter more than 12 meters and weighs around 3000 tonnes. Further development of the offshore wind industry will force to install turbines in less suitable sites with deeper water bodies, harsher environments, and possibly more problematic seabed.

Gravity-based foundations are currently the other common bases for offshore wind turbines. The gravity-based foundations were first used for oil and gas platforms where the weight of the foundation (typically in concrete) provides stability against the overturning moments resulting from lateral environmental actions like wind and wave on the structure.

In gravity-based foundations, the downward force due to the weight of the foundation together with the structure, resists the overturning moment by avoiding uplift of the foundation.

Conventional gravity-based foundations, as particularly used for offshore wind turbines, are usually composed of a conical, cylindrical or cubic hollow concrete foundation that is ballasted on site with water, sand, concrete, or iron ore. See references EP 2930273 B1, EP 2559814 B1, EP1777348 B1, EP2360373 B1, EP2643210B1, EP2933381B1, WO2009154472 and WO2016042173A1 for example. Common applications of gravity-based foundations are for offshore wind turbines, offshore platforms for the oil and gas industry, weather stations, and so on. Gravity bases are usually used at sites with a competent seabed that has a sufficient bearing capacity.

The conventional concrete gravity-based foundations for offshore wind turbines are massive. For example, a gravity-based foundation for a 7-megawatt wind turbine in the North Sea with a water depth of 30 meters, may have a base diameter of 31 meters, a height of 50 meters and a concrete volume of 2000 cubic meter, which may weigh about 5000 tonnes without ballast. The conventional concrete gravity-based foundations are fabricated in several stages at large quays with a high load bearing capacity. The fabrication continues 24/7 and takes several months to complete. They may be transported afloat to the installation site, but they may need to be lifted from the fabrication site to place them on a barge or in the water. At the installation site, the foundations are either flooded in a controlled manner till touch-down or lifted and lowered to the seabed which requires very large crane vessels.

The other type of foundation for offshore wind turbines is a steel jacket which is mostly used for rather deep waters. Jackets are lighter than concrete gravity bases but are usually expensive for fabrication and prone to fatigue damages at the intersection of members or so-called nodes. At very deep sees, floating offshore wind turbines may be used. Floating solutions are still very new in the market and are quite expensive. There are many floater concepts under development and there is not that much experience with the performance of floating wind turbines in real environment.

Onshore wind turbines are mostly based on either piled foundations or spread footings. See for example, U.S. Pat. No. 10,738,436 B, WO 2005/012651 A, WO 2017/101940 A. In case of piled foundations, the base usually composes of a stiff concrete pile cap with several (mostly concrete) piles under the pile cap. In case of a spread footing, usually the base is a reinforced concrete slab in the form of a large diameter truncated cone resting on the ground.

For other tall and slender onshore installations-such as monopoles, light poles, masts, lattice towers for telecommunication and power transmission, stacks, and chimneys—similarly one of these two foundation concepts, either piled foundations or spread footings are usually employed.

The objective of the present invention is to overcome one or more disadvantages of the prior art, or at least to provide an alternative to the prior art.

Further particular objectives of the present invention or embodiments thereof may include one or more of the following: to provide a gravity base, and more particular a gravity base for an offshore wind turbine, an onshore wind turbine, offshore platforms for oil and gas industry, weather stations, jackets, monopoles, light poles, masts, lattice towers for telecommunication and power transmission, stacks and chimneys and similar light and tall installations, which may have one or more of the following advantages: being more economical than the conventional gravity-based foundations; optimizing use of material and possibly usage of local site material; reducing lifting capacity needed for the transportation and installation of the foundation; avoiding the requirement of a construction site (such as a quay) with a high load bearing capacity; avoiding the requirement of a purpose-built equipment (e.g. a vessel) for lifting, transportation and installation; avoiding high levels of noise during installation; allowing faster fabrication, suitability for temporary applications, and giving the possibility to use its ballast and scour protection layers of gravel and/or sand as artificial reefs which provide holes to live or hide so attract different sea species and promote biodiversity.

One or more of the objects are achieved with the invention according to one or more of the appended claims, clauses, and/or according to one or more of the embodiments described herein. Combinations of several dependent claims and/or clauses may result in synergetic advantages.

In particular, the invention relates to a gravity base for a superstructure and to a method for deploying the gravity base, as well as a method for decommissioning a gravity base, and an offshore transportation method. The method according to the invention may be performed with the gravity base according to the invention and the gravity base according to the invention may be used for the method according to the invention; however neither are limited thereto. The features and embodiments described below can be part of either or both of the gravity base and the method, to achieve similar advantages.

The gravity base and method may e.g. be used for a non-building construction such as an offshore wind turbine, an onshore wind turbine, offshore platforms for the oil and gas industry, weather stations, jackets, monopoles, light poles, masts, lattice towers for telecommunication and power transmission, stacks and chimneys, temporary structures requiring fast and easy installation and decommissioning, and so on. The gravity base may e.g. comprise one or more of a base structure, a ballast confiner, and optionally a support structure.

In embodiments, the invention relates to a gravity base for supporting a superstructure as set out in claim 1 or claim 2. The main function of the base structure is to support the superstructure, e.g. directly or via a support structure, and transfer loads or moments to the supporting media. During use, a ballast material is arranged in the ballast confiner, which exerts a force onto the base structure. This force is mainly horizontally offset from a vertical axis of the superstructure and due to gravity directed downwards, such that the resulting moment counteracts a moment by lateral forces exerted onto the superstructure and/or the gravity base. Advantageously, the base structure and the ballast confiner are structurally independent. This has several advantages in view of constructions and installation, as explained further herein. It is noted that when ballast material is arranged in the ballast confiner, the ballast material is optionally also structurally independent from the base structure, and optionally also from the ballast confiner other than being spatially confined thereby.

For example, structurally independent may entail that the ballast confiner is stable on its own, wherein there is no support connection between the ballast confiner and the superstructure and/or between the ballast confiner and the support structure and/or between the ballast confiner and the base structure. For example, structurally independent may entail the superstructure or the support structure are mainly supported by components other than the ballast confiner.

Thus, there may be no structural connection between the ballast confiner and the base structure. It is noted that nevertheless, the ballast confiner can be arranged on the base structure in some embodiments, and the weight of the ballast confiner and/or the ballast can be supported by the base structure. In addition, some forces will be transmitted to the ballast confiner via the ballast material, e.g. in case of a non-rigid ballast.

The base structure and the ballast confiner may further be e.g. functionally independent, wherein optionally functionally independent may entail that the ballast confiner mainly acts to confine the ballast on the base structure in order to provide resistance for the base structure and thus the superstructure against applied loads and moments.

The invention can also relate to a gravity base without the ballast confiner, e.g. as set out in claim 7 or claim 8. In this case a ballast material is arranged on the base structure without a ballast confiner. The ballast material may e.g. be stable on itself. The ballast material may e.g. be concrete slabs or blocks. The ballast material and the base material are independent, e.g. structurally independent. The same advantages may apply as explained above when the ballast confiner and the base structure are structurally independent. In this case structurally independent may e.g. entail one or more of definitions given above, mutatis mutandis.

Summarized, the gravity bases of the invention can be described as a gravity base for supporting a superstructure such as an offshore wind turbine, comprising
a base structure, wherein the base structure is configured to be arranged on a supporting media and is configured to be connected to
   i. the superstructure or
   ii. to a support structure which is configured to be arranged between the superstructure and the base structure, and wherein the support structure is configured to be connected to the superstructure, wherein the gravity base further comprises one of
a ballast confiner, wherein the ballast confiner is configured to be filled with a ballast material, wherein the ballast confiner is configured to confine the ballast material on the base structure, wherein the base structure and the ballast confiner are structurally independent;
or
a ballast arranged on the base structure, wherein the ballast is a non-confined ballast, wherein the base structure and the ballast are independent, e.g. structurally independent.

The superstructure may e.g. be an offshore wind turbine, an offshore installation, an onshore wind turbine, offshore platforms for the oil and gas industry, weather stations, monopoles, masts, lattice towers for telecommunication and power transmission, light poles, chimneys, and any other installation. It will be understood that any references to such structures herein can be understood as applying generally to the superstructure in a given application. In embodiments, the superstructure may e.g. have a height or length of at least 1 meter, e.g. at least 10 meters, e.g. at least 25 meters, e.g. at least 50 meters, e.g. at least 100 meters, e.g. at least 150 meters. The invention may further relate to a combination of the superstructure and the gravity base.

In embodiments, the base structure may e.g. be a planar structure, preferably made of stiffened steel plates, that may e.g. be configured to lay on a supporting media (herein further also referred to as soil) and may e.g. be configured to be connected to the superstructure directly or may e.g. be configured to be connected to a support structure, preferably a steel shaft. The support structure may e.g. be configured to be arranged between the superstructure and the base structure. In embodiments, a diameter or width of the base structure may be between 0.1 meter and 80 meters, e.g. between 1 and 60 meters, e.g. between 20 and 50 meters. In embodiments, a height of the base structure may be between 0.1 meter and 60 meters, e.g. between 1 and 30 meters, e.g. between 10 and 20 meters. In embodiments, the base structure is configured to provide a distance between the supporting media and the superstructure, such that the superstructure e.g. does not come into contact with the supporting media or is not arranged in the supporting media.

In embodiments, the ballast confiner may e.g. be a shell, preferably in the form an upright cylinder with open ends e.g. in steel. The ballast confiner may e.g. be configured to be arranged on the base structure. The ballast confiner may e.g. be configured to be arranged directly on the supporting media. When the ballast confiner is arranged directly on the supporting media, the ballast confiner may be configured to penetrate partially into the supporting media. The ballast confiner may e.g. be configured to be filled with a ballast material (herein further also referred to as ballast), wherein the shell confines the ballast on the base structure. The weight of the ballast on the base structure provides stability for the gravity base and the superstructure against horizontal loads and overturning moments. In case of a self-stable ballast, e.g. concrete slabs or blocks, the ballast confiner may be omitted. In embodiments, a diameter or width of the ballast confiner may be between 0.2 meter and 100 meters, e.g. between 1 and 50 meters, e.g. between 10 and 25 meters. In embodiments, a height of the ballast confiner may be between 0.2 meter and 80 meters, e.g. between 1 and 50 meters, e.g. between 10 and 25 meters.

For offshore installations in deep seas, monopiles become rather uneconomical. Their diameter needs to be sufficiently large to provide enough bending stiffness for the turbine to reach a natural frequency above the lower limit of the allowable frequency range. Monopiles are also less suitable for sites with a shallow bedrock, boulders, or weak soil layers. Noises generated during pile driving are an environmental problem for sea creatures. There is a risk of pile and pile-tip buckling under the seabed due to need for employing larger hammers. Monopiles are also affected by scour.

Since the conventional gravity-based foundations for offshore installations are mostly large concrete structures, they are heavy for lifting, transportation, installation and require large quays with a high load bearing capacity or large dry docks. In addition, their construction is labour intensive, takes a rather long time, and requires a large piece of land on the port for fabrication and storing the completed foundations. The decommissioning of the conventional gravity bases can also be difficult and expensive. Afloat gravity-based foundations usually have a large draft at float-out which limits the choices in appropriate ports with a sufficient water depth. Afloat gravity bases are also sensitive to hydrodynamic instabilities during sinking and touch-down at the destination windfarm site.

In comparison with the known (monopile) foundations, the present invention can be used for larger offshore wind turbines, deeper waters, shallow bedrocks, soils with weak layers or boulders; and does not require purpose-built vessels and as large heavy lift cranes as cranes needed for concrete gravity bases; eliminates problems related to pile driving of large monopiles, such as noises; the design is universal so can easily be adapted for different site conditions; is easy for decommissioning where the material can be recycled, and can provide a refugium for the sea life.

Advantageously in the particular case of an offshore installation, this gravity base is more economical than the currently available foundation solutions and can support larger superstructures—for example wind turbines—in deeper water bodies. Currently most of offshore wind turbines are based on monopiles. For large wind turbines, the diameter, length, and wall thickness of the monopile must be very large, which makes the fabrication, transportation, up-ending, and driving of the monopiles very demanding. The present invention is more economical and environmentally friendly than the monopiles, eliminates or at least reduces problems related to pile driving. There is a reduced noise impact, and in embodiments there is no grouted connection. In embodiments no specialist vessel may be required and smaller heavy lift cranes may be required for the deployment of the foundation. It is less sensitive to soil conditions at site and can be used at sites with a shallow bedrock or boulders.

In comparison with the conventional gravity-based concrete foundations, the gravity base according to the present invention is lighter since the required weight for equilibrium and stability is mostly provided by ballast which is filled after the installation of the foundation, thus eliminates or at least reduces the need for heavy lift vessels and cranes with high lifting capacities during transportation and installation phases and thus corresponding considerable costs and schedule restrains. The initial draft of this gravity base at float-out is less than conventional gravity-based foundations and eliminates or at least reduces restrictions on the choices of suitable construction/assembly quays and transport ports.

This innovative gravity base is less sensitive to the site geotechnical conditions in comparison with monopiles and thus can be employed for windfarms with different soil types such as mobile sand banks, dense sand, stiff clays, rocky strata, boulder clay or a windfarm with variable soil conditions over the site.

In comparison with the conventional gravity bases, the bottom skin of the base structure of the present invention can be more flexible than the bottom slab of the usual concrete gravity bases especially near the outer edge. This results in a more uniform distribution of stresses on the supporting soil and particularly less stress concentrations in the soil near the edge of the base structure. Additionally, the present invention may take less wave and current load in comparison with the conventional gravity bases as its height can be lower and its width near the sea surface with the maximum wave load is limited to the width of the support structure. The low height of the present invention also results in reduced variation of the apparent weight of the foundation and thus the consequent eccentricity of the wave forces. This reduces cyclic loading of the soil which may occur in case of the typical gravity bases.

In case of offshore installations, the wave and current loads on the submerged part of the support structure except for the part above the ballast level are taken by the ballast confiner and transferred through the ballast to the base structure and seabed. This reduces forces and moments transferred via the support structure to the base structure. The ballast may also protect the base and support structures from marine growth.

In case of a solid ballast material, the ballast around the shaft may laterally support the shaft and reduces the bending moment in the lower confined part of the shaft. The ballast around the support structure and over the base structure may also increase the damping of the foundation which is desirable.

The present invention provides more flexibility in the adjustment of the support structure stiffness in comparison with the monopile foundations. In order to avoid resonance frequencies, the support structure stiffness can be reduced by reducing the shaft diameter and can be increased by adding ties/struts between the base structure and the shaft.

The secondary steel such as access ladders and platforms can be pre-installed on the foundation before installation. This omits the need for any transition piece and thus reduces expensive offshore lift and installation operations which is for example needed for the installation of the transition pieces on the monopiles.

In embodiments, the base structure and ballast confiner are structurally and/or functionally independent. Thus, the gravity base comprises two parts that are structurally and/or functionally independent. For example, the base structure and/or the ballast confiner can be fabricated in inland workshops. This allows them to be shipped—for example through inland canals—to the windfarm site, while the conventional concrete gravity foundations because of their large dimensions have the constraint that they must be built on a quay with a high load bearing capacity at the port which has a limited availability.

In embodiments, the base structure, support structure and/or ballast confiner can be fabricated overseas, where e.g. experienced and/or cheaper workmanship is available, and e.g. be shipped to the installation site. Steel fabricators with experience in the fabrication of steel bridges and shipbuilders also have the skills required for the fabrication of this gravity base.

In embodiments, the gravity base may comprise or be divided into sectors, wherein e.g. said sectors are constructed in parallel. This allows that the construction time of the present gravity base be shorter than the conventional concrete bases as the work can be easily performed in parallel by dividing the base structure into sectors. Since one or more parts of the gravity base, the base structure, and/or the ballast confiner may comprise and/or be made out of steel, it has an advantage over concrete which must be poured in stages with some extra time for fabricating reinforcing rebar cages, placing formwork, pouring concrete and waiting for concrete to harden.

In embodiments, the base structure may comprise several compartments. This helps to improve the hydrodynamic stability of the base structure if installed by ballasting and lowering or sinking the base structure to the seabed.

In embodiments the gravity base comprises a shaft. If desired, the shaft can also act as a buoyancy chamber during transportation, installation, and/or operation. The ballast confiner may also sealed to the base structure in order to increase buoyancy with a larger free surface.

In embodiments, the diameter and/or the height of the ballast confiner is adjustable. This allows to adjust the gravity base for the amount of ballast required for the stability of the gravity base. In embodiments, the density of the ballast is adjustable.

In embodiments, the ballast confiner comprises and/or is made out of tensile resistant materials such as steel, high strength steel, plastic, nylon, synthetic tissues, cable net, fibre reinforced plastic, fibre glass, aramid and similar materials. The ballast confiner is mainly subject to circumferential tensile stresses which eliminates risk of buckling and makes use of tensile resistant materials such as steel, high strength steel, plastic, nylon, synthetic tissues, cable net, aramid and similar materials economical.

In embodiments, the ballast confiner comprises and/or is made out of synthetic material. In case of a ballast confiner made of a synthetic material, there is less problem with corrosion.

In embodiments, the ballast confiner may be configured to act as a (perimeter or) peripheral skirt for the gravity base. In case of an offshore installation and in case of a soft seabed, the skirt may also increase the bearing capacity of the soil and thus makes this gravity base more viable.

In embodiments, the diameter of the ballast confiner may be larger than the width of the base structure. At sites where scour is probable, the diameter of the ballast confiner may be taken sufficiently larger than the width of the base structure in order to avoid scour to reach underneath the base structure and to negatively affect the performance of the base structure, and thus, reduces needs for scour protection.

In embodiments, the ballast confiner may be configured to extend above the water level. In shallow water bodies, the ballast confiner may extend above the water level, so protects the support structure from wave and current loads and corrosion in the splash zone and also provides a landing platform for access to the superstructure. At windfarm sites in cold regions, a ballast confiner extended above the water level may provide protection for the support structure against ice loading.

This gravity base concept in its whole or any components of it, e.g. the ballast confiner, may be used together or independently for other purposes, e.g. for anchoring the moorings of floating offshore wind turbines. In embodiments, the ballast confiner is configured to be used independently from the base structure and superstructure for a further function e.g. to anchor a further structure, and/or to provide stability for a further structure, and/or to provide a platform, and/or to act as an artificial reef. For example, in embodiments the invention can relate to a ballast confiner, wherein the ballast confiner is configured to be arranged on a supporting media and to be filled with a ballast material, wherein the ballast confiner is further configured to function as an independent structure. The ballast confiner can further be embodied according to any of the embodiments described herein.

In embodiments, at least a part or the whole gravity base including the base structure, the support structure and the ballast confiner can be made in steel. The steel can e.g. be retrieved from the installation site and recycled when the gravity base is decommissioned.

In embodiments, the ballast can be the local site soil excavated for foundation pit preparation. This can e.g. be the case in an onshore installation. This reduces the material and transportation costs.

In some embodiments in case of an offshore installation, a ballast confiner may temporarily be placed on the seabed next to the foundation pit and used to store the soil that has been dredged from the foundation pit during the seabed preparation. After the installation of the foundation, this stored soil can be taken back from the temporary ballast confiner and used to fill the permanent ballast confiner installed on the foundation then the temporary ballast confiner can be moved and reused for the next foundation.

The advantages of the present invention are explained by way of example and reference to the accompanying figures. The figures only serve as examples and are not meant to be construed as limiting the scope of the invention or the claims. Across the various figures like features are indicated by like reference numerals.

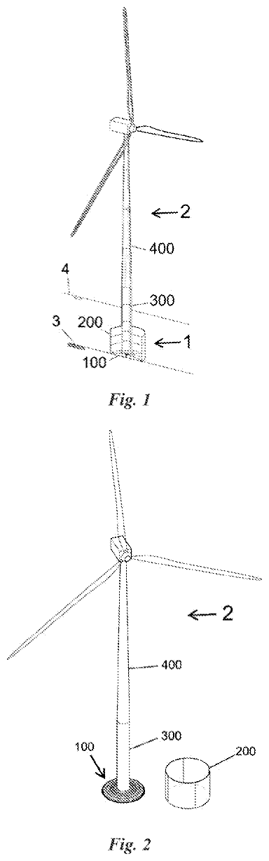

FIG. 1 is a perspective view of an offshore wind turbine and the gravity base in accordance with an embodiment of the present invention. In order to better show inside the foundation, half of the foundation and the tower is not shown.

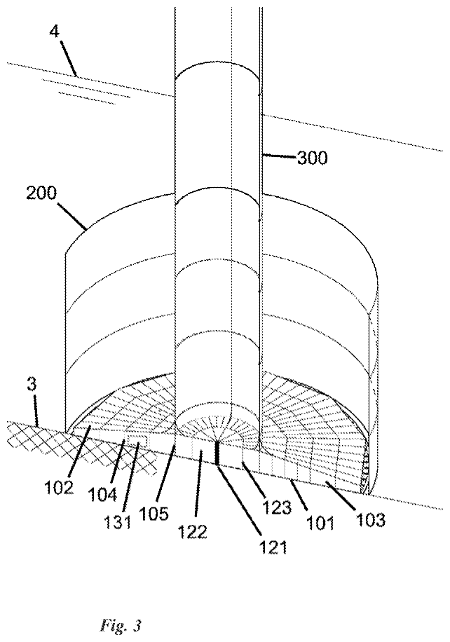

FIG. 2 is an exploded perspective view of an offshore wind turbine and the gravity base as shown in FIG. 1.

FIG. 3 is a zoomed perspective view of the gravity base as shown in FIG. 1.

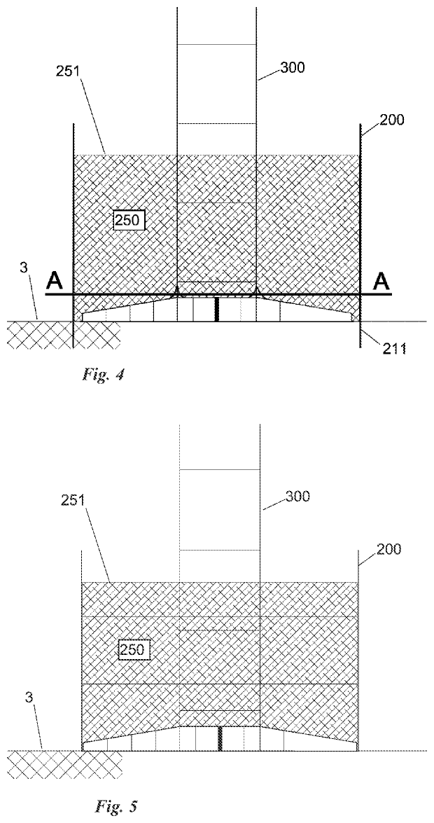

FIG. 4 is a cross-sectional view of the gravity base as shown in FIG. 3.

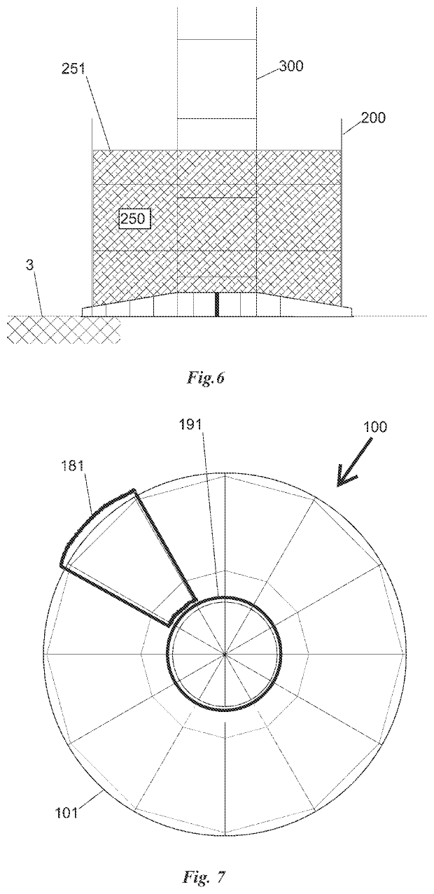

FIG. 5 and FIG. 6 are cross-sectional views of further embodiments of the gravity base, wherein the ballast confiner has a smaller diameter than the base structure and thus stands on the base structure.

FIG. 7 shows Section A-A of the gravity base as indicated in FIG. 4.

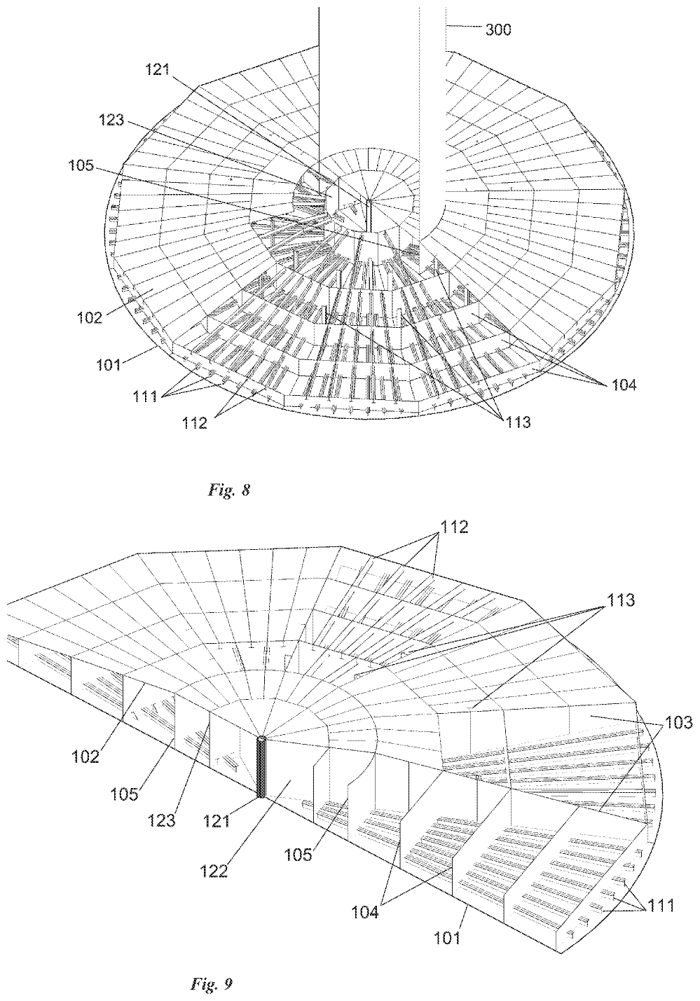

FIG. 8 is a zoomed perspective view of the base structure as shown in FIG. 1 wherein some components have been hidden to demonstrate the inside of the base structure.

FIG. 9 is a zoomed perspective view of half of the base structure which includes six sectors and half of the central part of the base structure in accordance with an embodiment wherein some components have been hidden to show inside.

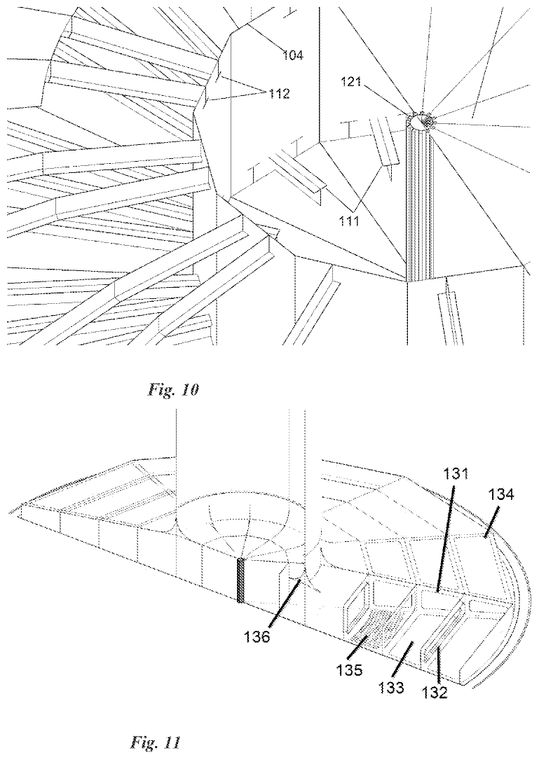

FIG. 10 is a perspective view of the central part of the base structure in accordance with an embodiment where some components have been hidden to show inside.

FIG. 11 is similar to FIG. 9 showing alternative embodiments of the base structure.

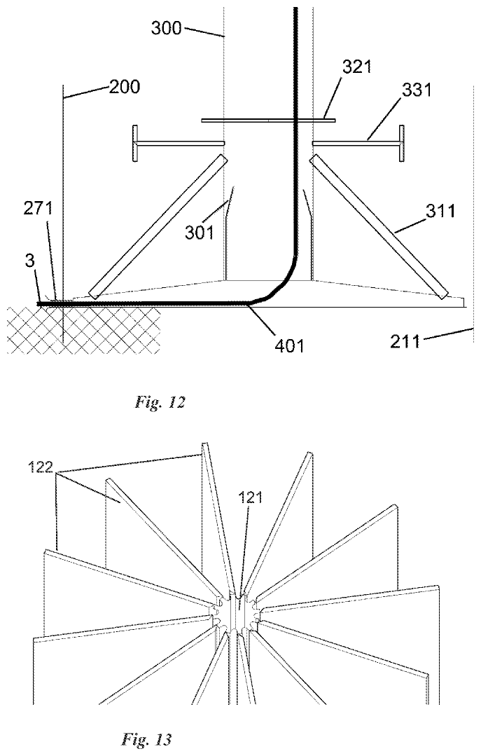

FIG. 12 is a cross-sectional view of an alternative embodiment for the support structure in the form of a braced shaft and some attachments. This cross-sectional view also shows the location where the power cables enter into the gravity base.

FIG. 13 is a cast piece with some of the rib plates located at the centreline of the support structure inside the base structure in accordance with an embodiment.

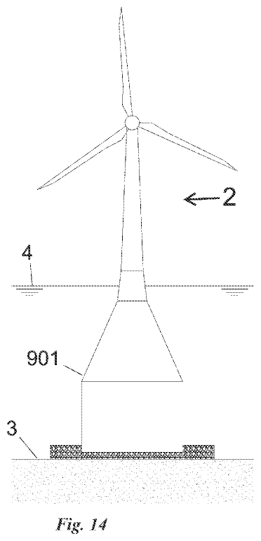

FIG. 14 is a side view of a conventional concrete gravity-based foundation for an offshore wind turbine in accordance with the prior art.

FIG. 1 and FIG. 2 show a non-restrictive example of the present invention that provides a gravity base 1 for a superstructure 2 and comprises a base structure 100, a ballast confiner 200, and if needed, a support structure 300. The base structure 100 is a planar structure that rests on a supporting media 3. The supporting media 3 may be the ground, seabed, a gravel bed or any other construction or material that supports the gravity base 1. The ballast confiner 200 confines a ballast and keeps the ballast on top of the base structure 100. The weight of the ballast on the base structure 100 provides stability for the gravity base 1 and the superstructure 2 against loads and moments, more specifically, horizontal loads and overturning moments. If necessary, a support structure 300 such as a shaft or a spatial structure (jacket) may be provided that connects the base structure 100 to a transition piece or to the superstructure 400.

In embodiments, as e.g. shown in FIG. 3, the gravity base 1 comprises a base structure 100, preferably in the form of a circle or a polygon laid on the supporting media 3, wherein the bottom side 101 of the base structure 100—directly or indirectly via secondary elements—is in contact with the supporting media 3 and the upper side 102 of the base structure 100 and/or the upper face of the bottom skin 101 of the base structure 100 is in contact with the ballast. A support structure 300—for example in the form of a cylindrical, truncated conical or prism shaft—may also be provided which connects the base structure 100, e.g. at the bottom side (of the support structure 300), to the superstructure 400 at its top side (of the support structure 300). The support structure 300 is configured to transfer actions including forces and moments that are applied on the superstructure 2 to the base structure 100, which in turn, is configured to transfer actions including forces and moments to the supporting media 3. The superstructure 400 may also be directly connected to the base structure 100 without any support structure 300. The support structure 300 may also be in the form of a braced frame, see FIG. 8, or a spatial truss-such as the so-called jacket for offshore installations—where the lower side of the frame or the legs of the jacket are supported by the base structure 100 and the top of the frame or the jacket supports the superstructure 400.

In embodiments, the ballast confiner 200 is e.g. a vertical cylinder or a truncated cone and can e.g. be open or closed on the bottom and/or top ends. The ballast confiner 200 can e.g. be configured to stand vertically on the supporting media 3 or on the base structure 100 as shown in FIG. 4, FIG. 5, and FIG. 6. In embodiments (e.g. in the case of a cylindrical ballast confiner 200 and a circular or polygonal base structure 100, when the cylinder has a diameter larger than the largest horizontal dimension of the base structure 100), the ballast confiner 200 may be configured to stand completely outside the base structure 100 on the supporting media 3. This is e.g. shown in FIG. 4. However it is also possible that in embodiments, the ballast confiner 200 is configured to be completely arranged on the base structure 100, as is e.g. shown in FIG. 5 and FIG. 6. This may e.g. be the case if the ballast confiner 200 has a diameter smaller than the width of the base structure 100. The bottom edge of the ballast confiner 200 may e.g. be sealed to the base structure 100, e.g. by means of a recess in the base structure 100, or a sealant or a grouted joint or any other suitable method, in order to avoid erosion of the ballast 250 from the ballast confiner 200.

In case of an offshore installation, when the diameter of the ballast confiner 200 is larger than the diameter or the largest width of the base structure 100, the bottom side of the ballast confiner may in embodiments be configured to penetrate in the soil and/or to act as a skirt 211 for the base structure 100, as is e.g. shown in FIG. 4. The skirt 211 may be configured to penetrate into the seabed under the self-weight of the ballast confiner 200 and may be configured to provide some protection against scour and an extra resistance for the gravity base 1 against horizontal loads. The skirt 211 may also be configured to confine the soil under the base structure 100 and thus increases the load bearing capacity of the soil under the base structure.

In embodiments, the ballast confiner 200 may also have any other suitable shape such as a cylinder, a truncated cone, any other surface of revolution, a prism, etc. For example, if the ballast confiner is made slightly conical, this allows nesting or stacking up several ballast confiners and thus a more compact storage after fabrication and during transportation. In case of cylindrical ballast confiners, the cylinders may have slightly different diameters for the same purpose of more compact storage or transportation and/or easier fabrication of more than one cylinder in parallel in upstand position.

The base structure 100 may in embodiments, as e.g. shown in FIG. 8 and FIG. 9 comprises a bottom skin 101, stiffened or not, with or without multiple compartments. In some embodiments, the bottom skin 101 and/or the top skin 102 may be perforated or have small or large openings, e.g. only act as the flanges of the ribs, in order to reduce the steel weight and/or to reduce the drainage path of the extra pore water pressure that may develop in the soil under the base structure due to cyclic loadings. The central circular part of the bottom skin below the shaft may also be left open for the same reason of steel weight reduction, pore water drainage, making stress distribution on the soil more uniform and thus reducing risk of rocking due to soil compaction under cyclic loading, and/or the possibility of a more compact stappling of the base structures for storage and during transportation, where the shaft stub of the lower base structure may stick inside the opening of the upper base structure. The base structure 100 can comprise or be made of steel, concrete, steel-concrete composite, or any other suitable material. In some embodiments the base structure can comprise a steel structure comprising a bottom skin 101 and a top skin 102—and optionally one or more intermediate horizontal skins—with several radial bulkheads 103 and secant bulkheads 104, e.g. in the form of trusses or stiffened plates or corrugated plates arranged in the radial direction as well as in the secant or tangential direction between the bulkheads in the radial direction. The bulkheads 103 and 104 may be equipped with openings 131 and 132 and/or watertight doors which e.g. allow the inspection of the base structure during the service life.

In some embodiments, a peripheral skirt or network skirts may be installed under the base structure in order to improve its sliding resistance, bearing capacity, scour resistance and/or to allow for an easier under base grouting.

The stiffeners of the bottom skin 111 may e.g. be configured to be placed on the lower face of the bottom skin 101. These stiffeners 111 may e.g. be configured to penetrate into the soil to provide extra resistance against sliding of the gravity base 1. The stiffeners may e.g. be configured to trap air and increase the buoyancy of the gravity base 1 during transportation and installation. After installation, the trapped air may be desired to be released by foreseen devices or processes.

In embodiments the base structure may be a concrete base structure. For example, the base structure may comprise a concrete slab or a hollow concrete slab, e.g. with top and bottom skins and optionally several vertical walls between the bottom skin and the top skin arranged in radial, tangential, secant or any other direction.

In embodiments, the support structure 300 comprises a vertical cylindrical hollow shaft, e.g. in the form of a large diameter steel pipe or a concrete cylinder, e.g. configured to be supported at its lower end by the base structure 100 and having a top end being configured to support the superstructure 400.

After installation, as shown in Error! Reference source not found., FIG. 5, and FIG. 6, the lower part of the support structure 300 can be filled with ballast 250, e.g. up to a ballast level 251. This increases the resistance of the gravity base 1 against overturning moments. This also reduces the risk of local buckling of the steel shell of the shaft as the shell is confined from inside and outside in the ballast, thus, the wall thickness of the shell may be reduced.

In embodiments, as e.g. shown in FIG. 11, the radial bulkheads 103, secant bulkheads 104, bottom skin 101, and top skin 102 may have openings 131, 132, 133, and 134. The bottom skin 101 may have several holes 135 which e.g. may serve to reduce the drainage path of any extra pore water pressure that may develop in the soil under the base structure due to cyclic loadings. There may be ribs 136 where the support structure 300 is connected to the radial ribs 103, e.g. in order to improve the fatigue performance of the gravity base.

In embodiments, as e.g. shown in FIG. 12, the support structure 300 may be connected to the base structure via slip joint 301, bolted joint, grouted joint or any other type of joint. The support structure 300 may comprise one or more braces 311 configured to be arranged around the shaft in the radial direction, e.g. between the base structure 100 and the shaft (e.g. above the shaft base or at a shaft top section). The braces 311 may e.g. be cables, tie-rods, steel tubes, or any other structural elements. The braces 311 may e.g. be configured every, 30, 45, 60, 90, 120 degrees, or any other degree around the support structure 300. The base structure 100 may provide a space 271, e.g. a J-tube, for the passage of the power cables 401. At the entrance of the power cables 401 in the ballast confiner 200, an opening with sealant all around is foreseen.

In embodiments, as e.g. shown in FIG. 12, additional elements, e.g. flanges 321 and/or deadman anchors 331, may be attached to the support structure 300. This may be done with the purpose of e.g. increasing the coupling between the support structure 300 and the ballast 250 to transfer loads from the support structure 300 to the ballast 250 or to modify the dynamics of the support structure 300. For example, a flange 321 may be added to the support structure at a ballast top section (e.g. near the top side of ballast 251). This may stiffen the support structure 300 and reduces its movements. For the same purposes, one or more tie-rods can e.g. be arranged between the support structure 300 and the ballast confiner 200.

In some embodiments, the support structure 300 may be welded to the base structure 100 or may be connected to the base structure 100 via joints such as a slip joint, bolted connection, grouted connection, or any other type of connection.

In embodiments, the support structure may be in the form of a 3-leg, 4-leg, 6-leg, or any other number of legs jacket, e.g. standing on a single base structure or on several independent or linked base structures.

In embodiments, the ballast 250 and the ballast confiner 200 may also be replaced by any other type of ballast such as concrete slabs or blocks that are piled on the base structure or any other type or form of ballast.

In embodiments, e.g. after the installation of the base structure 100, the support structure 300 (when present) and the ballast confiner 200, the ballast confiner 200 is filled with the ballast 250, e.g. from its top side. The ballast 250 may e.g. be configured to rest on the base structure 100 and at least partially fill up the ballast confiner 200. The weight of the ballast is applied to the base structure. The horizontal pressure of the ballast in the radial direction is resisted by the shell of the ballast confiner 200 which results in circumferential tensile stresses in the shell of the ballast confiner.

In embodiments, the ballast confiner can be made of normal or high strength steel plates, normal or prestressed concrete, plastic, nylon, cable net, synthetic membrane, aramid, or any other material with a tensile resistance.

In embodiments, the ballast confiner is made of high strength steel plates. Steel is commonly used for offshore constructions; the high tensile strength of steel—and especially of the high strength steels—is economical for structures subject to tensile forces. Moreover, steel is recyclable by the end of the service life of the installation or of the gravity base. The ballast confiner is less subject to fatigue.

In some embodiments, the ballast confiner may have two shells with a corrugated sheeting in between in order to increase its rigidity and stability during lifting, transportation and installation.

In some embodiments, the ballast confiner may have a sealant at its lower rim e.g. in order to fill any gap between the ballast confiner and irregularities in the seabed/gravel bed so e.g. to avoid or reduce any ballast erosion from the ballast confiner. The ballast confiner may also serve as a formwork for pouring concrete to reach a flat surface under the base structure or to increase the bearing capacity of the base structure. This concrete bedding may also serve to avoid any soil erosion under the base structure in case of gapping of the base structure under cyclic loads.

The ballast confiner may be hammered into the seabed in order to increase its penetration and thus to improve the scour protection provided for the base structure.

In embodiments, the power cables for the generator may enter inside the ballast confiner via an opening in the ballast confiner. The opening will be equipped with sealants all around to avoid any erosion of ballast from the ballast confiner. In embodiments, J-tubes may be foreseen inside the ballast confiner and the support structure which stick out of the ballast confiner. The power cables may also routed to go up on the side of the ballast confiner then pass above the ballast and enter the support structure.

In embodiments, the ballast can be a local material from the site, for example the excavated soil from the ground or the seabed for the preparation of the foundation pit. In embodiments the ballast can be shipped from elsewhere. The ballast can e.g. include materials such as one of or a combination of sand, ore, earth, gravel, concrete, demolished concrete, water, pebbles, and so on. In embodiments, the ballast may comprise a water reservoir, e.g. for an onshore gravity base. The water reservoir can serve other functions as well, such as a water reservoir or a fish farming pond.

In case of offshore installations, the ballast, e.g. in the form of gravel, may serve as a refugium for the sea life.

In case of a solid ballast, the ballast 250 around the support structure 300 may in embodiments be configured to laterally support the support structure and may be configured to reduce the bending moment in the lower confined part of the support structure. In other words, the lower part of the support structure 300 becomes embedded in ballast 250 and partially transfers loads to the ballast.

In case of offshore installations, an armour layer or a ring—for example steel plates, concrete mattress, or any other suitable shape or material—may in embodiments be configured to be placed on the seabed 3 around the ballast confiner 200. This may avoid scour or reduce the need for scour protection. In embodiments a ring may be configured to be placed on the ballast 250, e.g. inside the ballast confiner 200 around the shaft of the support structure. This may avoid any erosion of the ballast material by waves and current. The rings may comprise several pieces for easier fabrication, transportation, and installation.

Whilst the gravity base as described herein has been developed with a focus on offshore installations, this gravity base may be used for any offshore or onshore construction where the idea and the concept are found suitable to stabilize the foundation and the structure; for example, this gravity base may be used for an offshore installation, an offshore wind turbine, an onshore wind turbine, offshore platforms for the oil and gas industry, weather stations, monopoles, masts, lattice towers for telecommunication and power transmission, light poles, chimneys, and any other installation. Any component of the gravity base may be used independently if desired, e.g. the ballast confiner may be used to anchor the mooring system of floating offshore wind turbines.

In embodiments, the base structure has a dodecagon (twelve-sided polygon) shape in a plan view, see FIG. 7. The bulkheads 104 in the secant direction may e.g. be straight. The top skin 102 may e.g. be planar. This makes the fabrication of the base structure with a dodecagon plan easier than for example a base structure with a circular shape, where the top skin will not be planar but with a curvature and the bulkheads running between the bulkheads in the radial direction might be curved. For example, the base structure 100 can be divided into twelve sectors 181 of 30 degrees each, arranged all around a central cylindrical piece 191 comprising a lower part or the whole length of the shaft of the support structure, or left empty as a hole for a slip joint, grouted joint, or any other joint between the support structure 300 and the base structure 100. Each sector 181 of the dodecagon and the lower part of the support structure 191 can be fabricated independently in a shop and then all assembled together to make the base structure 100 at a proper site with an appropriate access to the installation site. This allows parallel fabrication of the gravity base components in one workshop or multiple workshops. Since the dimensions of the sectors are much smaller than the whole gravity base, the sectors may not need to be fabricated at an assembly yard with direct access to the installation site, but they may be fabricated in workshops with proper access to the assembly yard, e.g. via inland canals and waterways. As shown in FIG. 9, the bottom skin 101 of the base structure can e.g. be a stiffened plate like the orthotropic deck of steel bridges, a corrugated plate, a perforated plate or any other suitable form. The stiffeners 111 of the bottom skin can e.g. be arranged in radial direction and can e.g. be in the form of plates, bulb flats, troughs, I-, H-, T- or L-sections. The top skin 102 of each sector 181 can e.g. also be a stiffened plate, e.g. with some stiffeners 112 arranged in the radial direction. The top skin 102 can e.g. be fabricated in the upside-down position for more favourable welding positions. As shown in FIG. 9 and FIG. 10, the lower part of the support structure 191 may e.g. be fabricated separately. The length of the part can be e.g. selected depending on the transportation restrictions. In embodiments, the lower part of the support structure will be a few meters tall. As shown in FIG. 10, the bottom end of the support structure may e.g. comprise a stiffened steel plate where there are e.g. twelve radial bulkheads 122 aligned with the bulkheads 103 on the sides of the twelve sectors. There can e.g. be twelve secant bulkheads 123 inside the lower part of the shaft on top of its bottom skin 101 running between the radial bulkheads 122. There can e.g. be a piece 121 at the centreline of the lower part of the shaft inside the base structure on which the twelve radial bulkheads 122 are connected. As shown in FIG. 13, the piece 121 may e.g. be in the form of a prism, e.g. with a base in the form of a cogwheel with e.g. twelve teeth. The piece 121 may be fabricated by casting, machining, or any other suitable process. The radial bulkheads 122 may e.g. have a bevel groove edge preparation so that the bulkheads can be welded from one side to the central cast piece 121 with single sided full penetration butt welds, if desired, in a flat position. It is noted that although twelve has been illustrated as example in these figures, any other suitable number can be applied, e.g. three, four, five, six, seven, eight, nine, ten, eleven, or more than twelve.

In some embodiments, the support structure 300 is a steel shaft. The steel shaft can be fabricated e.g. by cold rolling steel plates in the form of cans and welding the cans together to make a pipe like the common practice for the fabrication of the monopiles.

In embodiments, the ballast confiner 200 may be fabricated by spirally welding steel coils. This is similar to what is used for the fabrication of large oil tanks. The steel may e.g. have different grades and/or thicknesses along the height of the ballast confiner.

In some embodiments, the ballast confiner 200 may be fabricated in two pieces. For example, two rectangular plates with a width equal to the height of the ballast confiner and a length equal to the half of the perimeter of the ballast confiner can be fabricated in flat position in a workshop and transported to the assembly yard, e.g. via inland canals. At the assembly yard, the two plates are set vertically in the shape of half a cylinder and welded together along their two vertical edges. The two plates may be fabricated out of hot-rolled steel coils. So, there are only welds between the steel coils along their long edges. These welds are not severely loaded and mostly act to seal the cans of the ballast confiner to each other. Thus, the welds can be partial penetration welds. The ballast confiner may also be fabricated in a larger number of pieces than two, e.g. in 4 if desired, in order to facilitate the transportation, handling and so on.

In embodiments, e.g. in case of an offshore installation, a method e.g. for the assembly of the gravity base may comprise one or more of the steps described below. The gravity base may e.g. be assembled at an assembly yard with suitable access to the installation site—for example a suitable quay. With referring to FIG. 1 to FIG. 13, the bottom skin sectors (including e.g. one or more of 101, 111, 103, 113 and 104) and the lower part of the support structure (including e.g. one or more of 105, 121, 122 and 123) are e.g. assembled together. The top skin sectors (including e.g. 102 and 112) are e.g. set on the bulkheads (including e.g. 103 and/or 104) and are e.g. welded. The upper part of the support structure 300 may e.g. be lifted and connected to the lower part 105 which may e.g. already be a part of the base structure 100. Depending on the available lifting capacity, the length of the lower and upper parts of the support structure can e.g. be optimized. The upper part can also e.g. comprise of more than one piece, e.g. when it is necessary because of the lifting capacity limitations. A temporary or permanent platform can e.g. be attached near the upper end of each part of the support structure, e.g. to allow an easier access for joining the two parts of the support structure together.

The base structure 100, the support structure 300 and the ballast confiner 200 may be transported apart or assembled together for transportation.

In case of an offshore installation, for load-out, the base structure may in embodiments be configured to float when not yet ballasted, e.g. in shallow water depths typical of port facilities. The base structure can e.g. be designed in a way that it can achieve this. The base structure can e.g. already be floated before the installation of the support structure, which reduces the required lifting capacity.

In case of an offshore installation, for transportation, the gravity base may in embodiments be shipped to the installation site afloat or on a vessel. Buoyant transportation avoids costly transportation vessels and the base structure can optionally be towed to the installation site, e.g. using (standard) tugboats. However, this gravity base is much lighter than the conventional concrete gravity bases so that if opted for lifted transportation e.g. on a vessel, a smaller crane or a smaller number of self-propelled modular transporters (SPMTs) than what is needed for conventional concrete gravity bases would be sufficient. In embodiments, extra air cushions may be used to float the gravity base for transportation and installation. A taller sidewall may also be foreseen all around the periphery of the base structure in order to increase its buoyancy.

In case of an offshore installation when the support structure is a steel shaft, the shaft may be transported to the installation site afloat or lifted. In case of afloat transportation, the shaft may be divided into several airtight compartments.

In case of an offshore installation, in embodiments, the ballast confiners may be in the form of cylinders or truncated cones, e.g. with slightly different diameters for each gravity base. This can be used in order to optimize the storage of the ballast confiners on the transportation vessel; e.g. by nesting cylindrical ballast confiners inside each other or stacking conical ballast confiners on top of each other during the transportation and minimizing the space occupied on the vessel.

In case of an offshore installation, the gravity base 1 may be installed at the installation site in several ways. The gravity base may be lifted and shipped on a vessel to the installation site or may be towed to the installation site afloat. At the installation site, the gravity base may be sunk or lowered to the seabed by means of e.g. a crane vessel. In each case, the components of the gravity base 100, 200 and 300 may be assembled together in order to handle them as one single piece or may be handled apart or some parts assembled together and some parts apart.

In case of an offshore installation, the base structure 100 may be installed at the offshore site in several ways. The base structure may e.g. be lifted and lowered to the seabed. For this purpose, e.g. a crane vessel, jack-up barge, floating crane, bespoke U-shaped barge, twin barges, or pontoon with a moon pool may e.g. be employed. In case of afloat transportation or if a crane-assisted installation method is chosen, some airtight compartments in the base structure 100 may be foreseen. The airtight compartments allow floating of the base structure and/or reduce the required lifting capacity during installation. The airtight compartments can e.g. be water ballasted to sink the base until touch-down. In embodiments the base structure may comprise several compartments, wherein the sinking operation can e.g. be controlled throughout the whole process while e.g. cranes or tugboats with ropes control the correct position and vertical alignment of the support structure.

In embodiments, the ballast confiner can be lifted and lowered to the seabed. In embodiments the ballast confiner can be hung on the base structure at the port and e.g. towed together with the base structure to the installation site and then e.g. lowered to the seabed using remote controlled winches or tugs. In case where the ballast confiner has a smaller diameter than the width of the base structure, see FIG. 5 and FIG. 6, the ballast confiner may e.g. be laid on the base structure and sunk together with the base structure. After the installation of the base structure including the support structure (when present) and the ballast confiner, the ballast confiner may be filled with ballast. Finally, the superstructure is e.g. lifted and installed on the support structure, e.g. if the superstructure has not already been installed on the support structure at the port.

In embodiments in case of an offshore installation, a supporting and guiding structure may be foreseen at the water level to support the ballast confiner in the horizontal (radial) directions and guide it to its correct location with respect to the rest of the gravity base. This supporting and guiding structure provides a lateral support for the shell of the ballast confiner against horizontal loads near the water level like wave, wind and current. This supporting and guiding structure may be floating or not. It may keep its location by connections to the support structure, e.g. it can be in the form of a ring pontoon made of two or more circular sectors arranged around the steel shaft of the support structure. It has a circular hole in the middle with a diameter larger than the diameter of the steel shaft. Its outer diameter is smaller than the inner diameter of the ballast confiner. There are rollers at e.g. 3 levels at several locations around its periphery, e.g. at 12 locations, which provide horizontal supports for the ballast confiner in the radial direction and guide the ballast confiner to its position during installation.

In embodiments, wherein the ballast is stable without a ballast confiner, e.g. concrete slabs or blocks that are piled on the base structure, the ballast confiner may be omitted.

In case of water ballasting of the base structure, the hydrodynamic stability of the base structure can in embodiments be controlled by an appropriate arrangement of its compartments and ballasting e.g. according to a well-studied procedure. For example, the base structure 100 may be divided into two main compartments, e.g. one cylindrical internal compartment (e.g. including 191 and the lower part of the support structure), and e.g. one outer compartment e.g. in the shape of a toroid around the internal compartment. Optionally, the internal and outer compartments as well as the shaft may be divided into smaller compartments for a better hydrodynamical stability control during ballasting in order to guarantee a positive metacentric height during the whole process of installation.

In case where the stiffeners of the base structure are installed underneath the bottom face of the base, if the self-weight of the base structure and the weight of the ballast are not enough to force the stiffeners of the base to penetrate into the soil, it may e.g. be opted to use suction underpressure underneath the bottom skin in order to reach the target penetration.

In order to meet the allowed tolerance of rotation at the top of the support structure, the seabed may e.g. be levelled to a certain degree or a gravel bed may be installed. The desired level of the flatness of the bed depends on the width of and structure of the base structure, height of support structure which is a function of the water depth, resistance properties of the soil, and deformation tolerances.

In case of an onshore installation, the base structure can e.g. be shipped as a whole, in sectors, or in smaller pieces to the site and assembled together at the final location of the installation. The ballast confiner can e.g. be installed before or after the installation of the base structure. The support structure or the lower part of the superstructure can e.g. be taller than the height of the ballast confiner and can e.g. be installed before filling the ballast confiner with ballast.

At the end of the service life of the installation, the gravity base may e.g. be decommissioned by first removing the ballast and then transporting the base structure and the ballast confiner for recycling. The ballast may e.g. be removed from the top side of the ballast confiner and/or by making an opening in the lower part of the shell or opening a gate near the bottom part of the ballast confiner. In case of an offshore installation, the base structure may e.g. be lifted or floated for removal. If authorities allow and found it to be more economical and environmentally friendly, e.g. the whole gravity base may be left in place to continue its function as an artificial reef for the marine ecosystem, or e.g. only the support structure or the support structure and the ballast confiner are removed and the rest which are deep below the water surface are left in place.

Possible features of the invention are further exemplified by means of a non-restrictive example of an embodiment for the gravity base of a 20-megawatt offshore wind turbine installed at a water depth of 50 meters by referring to FIG. 1 to FIG. 13. The nacelle is located at 165 meters above the sea level and the rotor has a diameter of 270 meters. The weight of the superstructure including the tower, the rotor nacelle assembly and blades is assumed to be equal to 32 MN (mega Newtons). The maximum overturning moment at the seabed level due to wind, wave and current actions in the ultimate limit state (ULS) is 2000 MN.m (mega Newton meters) and the horizontal loads in the ULS are in total equal to 20 MN. These are estimations of the ultimate limit state forces acting on the foundation during its service life, however the real loads depend on the site conditions of the wind turbine.

The base structure 100 has a dodecagon shape in a plan view and its circumdiameter is 40 meters. The height of the base structure 100 near the support structure 300 is 4 meters and at the perimeter of the base is 1 meter. The base structure 100 is divided into twelve sectors of 30 degrees each. Each sector is separated from the adjacent sectors with bulkheads 103 on its sides in the radial direction. The radial bulkheads 103 are e.g. stiffened steel panels with e.g. some vertical and/or horizontal stiffeners 113. The bottom skin 101 and the top skin 102 of each sector have several stiffeners (111 and 112) in the radial direction. These radial stiffeners (111 and 112) are supported through bulkheads 104 arranged in the secant direction.

The support structure 200 is a hollow steel shaft with a diameter of 12 meters and a length of 70 meters which runs from the bottom skin 101 of the base structure 100 to 20 meters above the sea level 4. The wall thickness of the shaft varies along its height. The bottom side of the shaft is closed with a steel plate reinforced with stiffeners arranged in the radial direction which are aligned with the radial stiffeners 111 of the bottom skin of the sectors. There are twelve radial bulkheads 122 with a height of 4 meters inside the lower part of the shaft. These bulkheads 122 are aligned along the radial bulkheads 103 of the outer sectors of the base structure 100. The radial bulkheads 122 are welded to a cast piece 121 with a circumdiameter of 500 mm and a height of 4 meters located at the centreline of the shaft. There is a ring of secant bulkheads 123 inside the lower part of the shaft with a height of 4 meters. The circumdiameter of the secant bulkhead 123 is 7 meters.

The ballast confiner 200 has a diameter of 42 meters, and a height of 22 meters which is filled by sand up to 2 meters below the ballast confiner 200 upper end.

The foundation pit is prepared by e.g. dredging any mud and loose layers on the seabed and placing a gravel bed if needed. After the installation of the foundation, armour layers around the ballast confiner and on top of the ballast are added if there is any risk or scour or erosion.

The site and soil conditions, foundation dynamics, fatigue limit state verifications, and deformation tolerances in term of maximum allowable tilt at the top of the support structure may also require adjusting the dimensions given above for the gravity base and support structure.

As required, detailed embodiments of the present invention are described herein; however, it is to be understood that the disclosed embodiments are merely examples of the invention, which may be embodied in various ways. Therefore, specific structural and functional details disclosed herein are not to be construed as limiting, but merely as a basis for the claims and as a representative basis for teaching those skilled in the art to practice the present invention in various ways in virtually any suitable detailed structure. Not all of the objectives described need to be achieved with particular embodiments.

Furthermore, the terms and expressions used herein are not intended to limit the invention, but to provide an understandable description of the invention. The words “a”, “an”, or “one” used herein mean one or more than one, unless otherwise indicated. The terms “a multiple of”, “a plurality” or “several” mean two or more than two. The words “comprise”, “include”, “contain” and “have” have an open meaning and do not exclude the presence of additional elements. Reference numerals in the claims should not be construed as limiting the invention.

The mere fact that certain technical features are described in different dependent claims still allows the possibility that a combination of these technical measures can be used advantageously.

The invention may also be summarized by one or more of the following clauses:
1. A gravity base (1) for supporting a superstructure (2).
2. The gravity base according to clause 1, comprising a base structure (100), which e.g. is a planar structure.
3. The gravity base according to clause 1, wherein the base structure is configured to be arranged on a supporting media (3) and/or is configured to be connected to
   the superstructure (2), e.g. directly, or
   to a support structure (300) which is configured to be arranged between the superstructure and the base structure, and wherein the support structure may e.g. be configured to be connected to the superstructure.
4. The gravity base according to any of the preceding clauses, comprising a ballast confiner (200), wherein optionally the ballast confiner is configured to be arranged:
   on the base structure (100), e.g. at least partially or completely, or
   at least partially on the supporting media (3) and optionally also partially on the base structure.
5. The gravity base according to any of the preceding clauses, wherein the ballast confiner is configured to be filled with a ballast material (250), wherein optionally the ballast confiner (200) is configured to confine the ballast (250) on the base structure (100).
6. The gravity base according to any of the preceding clauses, wherein the base structure and the ballast confiner are structurally independent, wherein optionally structurally independent entails that:
   the superstructure (400) or the support structure (300) are mainly supported by components other than the ballast confiner, and/or
   the ballast confiner (200) is stable on its own, wherein e.g. there is no support connection between the ballast confiner (200) and the superstructure (400) and/or between the ballast confiner (200) and the support structure (300) and/or between the ballast confiner (200) and the base structure (100).
7. The gravity base according to any of the preceding clauses, wherein the supporting media (3) can be the ground, seabed, a concrete slab, a backfill or any other material or structure that can e.g. be configured to support the gravity base (1) and the superstructure (2).
8. The gravity base (1) according to any of the preceding clauses, wherein the base structure (100), in plan view, is preferably in the form of a dodecagon, a circle, a disc, or a polygon configured to be arranged on the supporting media (3), wherein optionally its bottom side-directly or indirectly via secondary elements—is configured to be in contact with the supporting media (3) and optionally its upper side is configured to be in contact with the ballast (250).
9. The gravity base (1) according to any of the preceding clauses, wherein the base structure (100) may comprise a bottom skin (101), stiffened or not, with or without a top skin (102), stiffened or not, and optionally one or more vertical bulkheads (103, 104), e.g. in the form of trusses, stiffened or corrugated plates, or walls arranged in the radial direction and/or in the secant and/or tangential direction between the bulkheads in the radial direction;
   wherein optionally the bulkheads are configured to transfer the loads from the support structure (300), when present, and/or (directly) from the superstructure (400), e.g. if no support structure (300) is present, to the bottom skin (101) and/or top skin (102); wherein optionally the bulkheads (103,104) are configured to reinforce the bottom skin (101) and/or the top skin (102) and optionally connect the bottom skin (101) to the top skin (102);
   wherein optionally the bulkheads may or may not divide the base structure (100) into multiple compartments;
   wherein optionally the base structure may be made of steel, concrete, steel-concrete composite, or any other suitable material.
10. The gravity base (1) according to any of the preceding clauses, wherein the stiffeners (111) of the bottom skin (101) of the base structure (100) may be located on the lower face of the bottom skin; wherein optionally these stiffeners (111) are configured to penetrate into the soil, e.g. to provide an extra resistance against sliding of the base, and/or provide extra buoyancy during transportation and installation.
11. The gravity base (1) according to any of the preceding clauses, wherein the ballast confiner (200)
   may e.g. be a shell with a cylindrical, conical or any suitable shape, such as any surface of revolution, and/or
   can optionally be open or closed on bottom and/or top ends, and/or
   is optionally configured to be arranged vertically either on the base structure (100) or directly on the supporting media (3), and/or
   is optionally configured to be filled with a ballast material (250), and/or
   may optionally be used alone for anchoring, e.g. for anchoring the mooring system of floating offshore installations, and/or
   may optionally have
      i. either a diameter larger than the largest horizontal dimension of the base structure (100), e.g. so that the ballast confiner (200) is configured to extend out of the base structure and is configured to be arranged at least partially on the supporting media (3), or
      ii. a diameter smaller than the width of the base structure (100), e.g. so that the ballast confiner (200) is configured to be arranged on the base structure (100);
   may optionally be made of normal or high strength steel, reinforced or prestressed concrete, plastic, nylon, synthetic membrane, aramid or any other suitable material;
   is optionally—e.g. after the installation of the base structure (100), the support structure (300), when present, and the ballast confiner (200)—configured to be filled with ballast (250) which is configured to rest on the base structure (100) and to fill up the ballast confiner (200); wherein optionally the ballast (250) can be one of or a combination of sand, ore, earth, gravel, concrete, demolished concrete, water or any other suitable material.
12. The gravity base (1) according to any of the preceding clauses, wherein the ballast confiner (200) in case of a liquid ballast may be sealed in the bottom side or its bottom end be sealed to the base structure (100), e.g. to provide a watertight container; wherein optionally the ballast confiner (200) may be omitted in case of a stable ballast which does not need any confinement.
13. The gravity base according to any of the preceding clauses, wherein e.g. in case of an offshore installation, the diameter of the ballast confiner (200) is larger than the diameter or the largest width of the base structure (100), wherein optionally the bottom side of the ballast confiner may be configured to penetrate into the soil and/or to act as a skirt (211) or not for the base structure (100); wherein the skirt (211) provides protection against scour and extra resistance for the base structure (100) against horizontal loads; wherein optionally the skirt (211) may be configured to confine the soil under the base structure (100) and e.g. thus increases the load bearing capacity of the soil.
14. The gravity base (1) according to any of the preceding clauses, wherein e.g. in case of an offshore installation, e.g. to avoid or reduce scour:
   a weight in the form of a ring or any other suitable form made of steel, concrete, or any other suitable material may be placed on the ballast (250) inside the ballast confiner around the support structure (300), in order to protect the ballast (250), and/or
   a weight in the form of a ring or any other suitable form made of steel, concrete, or any other suitable material may be placed around the ballast confiner (200) on the seabed (3).
15. The gravity base (1) according to any of the preceding clauses, wherein
   the support structure (300), when present, connects the base structure (100) at its bottom side to the superstructure (400) or a transition piece at its top side and is optionally one of a hollow shaft or a braced hollow shaft in the form of a cylinder or prism-such as a steel pipe or a hollow or solid concrete cylinder- or a spatial structure, a 3-leg, 4-leg, 6-leg or any other number of legs jacket, standing on a single base structure (100) or on several independent or linked base structures, and optionally is configured to transfer actions and/or forces that are applied on the superstructure (2) and/or on the support structure (300) to the base structure (100), which in turn, is configured to transfer actions and/or forces to the supporting media (3);
   wherein the support structure may optionally be configured to be partially or completely filled with a ballast (250);
   wherein optionally the support structure (300) may have one or more braces (311) arranged around it in the radial direction between the base structure (100) and the support structure (300), e.g. above its base or near a top section; wherein the braces (311) may e.g. be in the form of cables, tie-rods, steel tubes, or any other structural elements arranged every, for example 30, 45, 60, 90, 120 degrees, or any other degree around the shaft;
   wherein optionally the support structure (300) may have one or more attachments (321, 331), e.g. configured to increase its coupling with the ballast (250) and/or with the ballast confiner (200), e.g. configured to transfer part of the loads from the support structure (300) to the ballast (250) and/or to the ballast confiner (200) and/or to modify the dynamics of the support structure, and/or comprising some ties or any other type of elements connecting the support structure (300) to the ballast confiner (200).
16. The gravity base according to any of the preceding clauses, configured to be employed to support a superstructure or installation for an offshore or onshore construction; for example: for an offshore wind turbine, an onshore wind turbine, offshore platforms for the oil and gas industry, weather stations, monopoles, masts, lattice towers for telecommunication and power transmission, light poles, chimneys, temporary structures requiring fast and easy installation and decommissioning, and so on.
17. A wind farm, comprising at least one gravity base according to any of the previous clauses.
18. A deployment method of a gravity base (1), wherein optionally the gravity base is according to any of the preceding clauses, wherein optionally the gravity base is for an offshore installation.
19. The deployment method according to the previous clause, comprising one or more of the following steps:
   floating the base structure (100) with or without the support structure (300), with or without the ballast confiner (200) for transportation;
   sinking the base structure (100) at the installation site till touch-down with the seabed.
20. A decommissioning method of a gravity base (1), wherein optionally the gravity base is according to any of the preceding clauses, wherein optionally the gravity base is for an offshore installation.
21. The decommissioning method according to the previous clauses, comprising one or more of the following steps:
   removing a ballast (250);
   wherein the ballast (250) may e.g. be removed from the top side of the ballast confiner (200) or removed by making an opening in the lower part of the shell or opening a gate near the lower end of the ballast confiner (200);
   transporting a base structure (100) and a ballast confiner (200), e.g. for recycling;
   wherein the base structure (100) may e.g. be lifted or floated for removal.
22. An offshore transportation method wherein the cylindrical and truncated conical components, such as e.g. the ballast confiners (200) according to one of the previous clauses are made with slightly different diameters in order to allow nesting these components inside each other for minimizing the occupied space of the components during storage and transportation.

1. A gravity base for supporting a superstructure such as an offshore wind turbine, comprising a ballast confiner, wherein
the ballast confiner is configured to be filled with a ballast material, wherein the ballast confiner is configured to confine the ballast material on a base structure, wherein the base structure
is configured to be arranged on a supporting media and is configured to be connected to
the superstructure or
to a support structure which is configured to be arranged between the superstructure and the base structure, and
wherein the support structure is configured to be connected to the superstructure
wherein the ballast confiner is configured to be structurally independent from the base structure.

2. The gravity base according to claim 1, further comprising the base structure, wherein the base structure and the ballast confiner are structurally independent.

3. The gravity base according to claim 1, wherein structurally independent entails that the ballast confiner is stable on its own, wherein there is no supporting connection between the ballast confiner and the superstructure and/or between the ballast confiner and the support structure and/or between the ballast confiner and the base structure.

4. The gravity base according to claim 1, wherein structurally independent entails the superstructure or the support structure are mainly supported by components other than the ballast confiner.

5. The gravity base according to claim 1, wherein the ballast confiner has a diameter larger than the largest horizontal dimension of the base structure, so that the ballast confiner is configured to stand at least partially outside the base structure and is configured to be arranged at least partially on the supporting media.

6. The gravity base according to claim 1, wherein the ballast confiner is configured to be used independently from the base structure and superstructure for a further function e.g. to anchor a further structure, and/or to provide stability for a further structure, and/or to provide a platform, and/or to act as an artificial reef.

7. A gravity base for supporting a superstructure such as an offshore wind turbine, comprising
a base structure, wherein the base structure is configured to be arranged on a supporting media and is configured to be connected to
the superstructure or
to a support structure which is configured to be arranged between the superstructure and the base structure, and wherein the support structure is configured to be connected to the superstructure,
a ballast arranged on the base structure, wherein the ballast is a non-confined ballast, wherein the base structure and the ballast are independent.

8. The gravity base according to claim 7, wherein the ballast is stable without a ballast confiner, wherein the ballast confiner is omitted.

9. The gravity base according to claim 1, wherein the base structure comprises a bottom skin, and one or more bulkheads;
wherein the bulkheads are configured to transfer the loads from the support structure, when present, and/or from the superstructure, e.g. if no support structure is present, to the bottom skin;
wherein the bulkheads are configured to reinforce the bottom skin;
wherein the bulkheads may or may not divide the base structure into multiple compartments.

10. The gravity base according to claim 9, wherein the stiffeners of the bottom skin of the base structure may be located on the lower face of the bottom skin; wherein these stiffeners are configured to penetrate into the soil, e.g. to provide an extra resistance against sliding of the base, and/or provide extra buoyancy during transportation and installation, and/or provide formwork for concreting under the base structure.

11. The gravity base according to claim 1, wherein the ballast confiner in case of a liquid ballast is sealed on the bottom side or its bottom end be sealed to the base structure, e.g. to provide a watertight container.

12. The gravity base according to claim 1, wherein e.g. in case of an offshore installation, the diameter of the ballast confiner is larger than the diameter or the largest width of the base structure,
wherein the bottom side of the ballast confiner is configured to penetrate into the soil and/or to act as a skirt for the base structure; wherein the skirt is configured to provide protection against scour and extra resistance for the base structure against horizontal loads;
wherein the skirt is configured to confine the soil under the base structure and e.g. thus increases the load bearing capacity of the soil.

13. The gravity base according to claim 1, wherein e.g. in case of an offshore installation, e.g. to avoid or reduce erosion or scour:
an armour layer or a weight in the form of a ring or any other suitable form made of steel, concrete, or any other suitable material is placed on the ballast inside the ballast confiner around the support structure, in order to protect the ballast, and/or
an armour layer or a weight in the form of a ring or any other suitable form made of steel, concrete, or any other suitable material is placed around the ballast confiner on the seabed.

14. A wind farm, comprising at least one gravity base according to claim 1.

15. A deployment method of a gravity base, wherein the gravity base is according to claim 1, wherein the method comprises a step of arranging the gravity base on the supporting media.

16. A decommissioning method of a gravity base, wherein the gravity base is according to claim 1, comprising one or more of the following steps:
removing a ballast;
wherein the ballast is removed from the top side of the ballast confiner and/or removed by making an opening in a lower part of the ballast confiner or opening a gate near the lower end of the ballast confiner;
transporting a base structure and a ballast confiner, e.g. for recycling;
wherein the base structure is lifted or floated for removal.

17. A transportation method wherein the cylindrical components, being the ballast confiners as claimed in claim 1 are made with slightly different diameters or are made like truncated cones in order to allow nesting these components inside each other for minimizing the occupied space of the components during storage and transportation and/or facilitating their fabrication.
